(19) United States
(12) Patent Application Publication
(10) Pub. No.: US 2004/0205148 A1
(43) Pub. Date: Oct. 14, 2004

(54) Method for operating a computer cluster

(75) Inventors: Myung Mun Bae, Pleasant Valley, NY (US); Reinhard Buendgen, Tuebingen (DE); Felipe Knop, Poughkeepsie, NY (US); Gregory D. Laib, Kingston, NY (US)

Correspondence Address: William A. Kinnaman, Jr., IBM Corporation, MS P386, 2455 South Road, Poughkeepsie, NY, 12601, US

(73) Assignee: International Business Machines Corporation, Armonk, NY

(21) Appl. No.: 10/778,838

(22) Filed: Feb. 13, 2004

(30) Foreign Application Priority Data
Feb. 13, 2003 (EP) 03100328.8

(51) Int. Cl. G06F 15/167; G06F 15/177

(52) U.S. Cl. 709/213; 709/222

(57) ABSTRACT

The invention allows for dealing with failures that may result in split-brain situations. In particular the safe management of shared resources is supported even though the owners of a shared resource may be subject to split-brain situation. In addition our invention allows us to update the cluster configuration despite the fact that some members of the cluster cannot be reached during the reconfiguration. The policies imposed by our invention ensure that all nodes started always use the up-to-date configuration as working configuration or if that is not possible the administrator is warned about a potential inconsistency of the configuration.

### BACKGROUND OF THE INVENTION

1. Field of the Invention

The present invention generally relates to computer clusters. Particularly, the present invention relates to a method and system for operating a high-availability cluster.

2. Description of the Related Art

The invention relates to clustering techniques that deal with the fact that in certain failure situations it is hard if not impossible to decide whether a component of the cluster has failed or whether the communication link to that component has failed. Such situations are sometimes called “split-brain situations” because such failures may lead to situations where different sets of cluster components try to take over the duty of the cluster. The latter may be harmful, e.g., if more than one component tries to own shared data.

Different protection mechanisms have been suggested to deal with that kind of problem, like storing data on lock-protected (reserve/release) disks, using majority rules in a three-node cluster, or mutual “shoot the other node in the head” (STONITH) methods. Yet all these solutions are strongly restricted to special applications, availability of special hardware, certain cluster topologies, or fixed cluster configurations.

Starting from this, an object of the present invention is to provide a method and a system for securely operating a high-availability computer cluster.

### BRIEF SUMMARY OF THE INVENTION

The foregoing object is achieved by a method and a system as laid out in the independent claims. Further advantageous embodiments of the present invention are described in the subclaims and are taught in the following description.

The invention allows for dealing with failures that may result in split-brain situations. In particular the safe management of shared resources is supported even though the owners of a shared resource may be subject to a split-brain situation. In addition the invention allows one to update the cluster configuration despite the fact that some members of the cluster cannot be reached during the reconfiguration. The policies imposed by the invention ensure that all nodes started always use the most up-to-date configuration as the working configuration, or, if that is not possible, the administrator is warned about a potential inconsistency of the configuration.

The control of shared resources is based on a quorum that either uses majority rule (current cluster has a majority of nodes with respect to the defined cluster) to determine which connected subcluster is in charge of the critical resource or, in a tie situation, may consult a tiebreaker to obtain that decision. A tiebreaker is a mechanism (possibly with hardware support) that allows at most one winner within a competition. For subclusters not having a quorum, resource protection mechanisms are provided that may force the halt or reboot of a node. Such resource protection mechanisms are only used on nodes that actually hold resources that are specified to be “critical”.

With regard to (re)configuration of the cluster, numerical arguments are imposed on certain operations (like adding a node to the cluster, removing a node from a cluster and starting a node) that allow for a maximal number of failures while still allowing one to start the cluster if only half of its defined nodes are accessible.

In addition the invention relates to dealing with temporary network failures that may require merging two subclusters after the connection has been re-established.

### BRIEF DESCRIPTION OF THE SEVERAL VIEWS OF THE DRAWINGS

The above, as well as additional objectives, features and advantages of the present invention will be apparent in the following detailed written description. The novel features of the invention are set forth in the appended claims. The invention itself, however, as well as a preferred mode of use, further objectives, and advantages thereof, will best be understood by reference to the following detailed description of an illustrative embodiment when read in conjunction with the accompanying drawings, wherein:

FIG. 1 is a block diagram illustrating the hardware components forming a cluster;

FIG. 2 is a block diagram of a cluster experiencing a real cluster split;

FIG. 3 is a block diagram of a cluster having a potential cluster split;

FIG. 4 is a detailed block diagram illustrating the cluster's software stack as implemented in each node;

FIG. 5 is a block diagram illustrating software and hardware layers of a first node and a second node together with their accessibility and potential failure points;

FIG. 6 is a block diagram of a first and a second node illustrating the functionality of a cluster-wide resource management service;

FIG. 7 is a block diagram of a computer system illustrating the operation of a configured cluster;

FIG. 8 is a flow chart illustrating the information flow among cluster components;

FIG. 9 is a state diagram illustrating different operational states of a single node;

FIG. 10 is a flow chart illustrating the dependencies of a system's self-surveillance;

FIG. 11a is a block diagram of a cluster having a cluster split situation;

FIG. 11b is a block diagram of a cluster in which the connectivity has been re-established;

FIG. 11c is a block diagram of a cluster being in merge phase 1, namely, in the phase of dissolving a subcluster;

FIG. 11d is a block diagram of a cluster being in merge phase 2, namely, in the phase of the first node joining;

FIG. 11e is a block diagram of a cluster being in merge phase 3, namely, in the phase of the second node joining;

FIGS. 12a-e are block diagrams illustrating examples of the configuration quorum;

FIGS. 13a-c are a block diagram illustrating an example of an operational quorum for a two-node cluster with a critical resource;

FIG. 14 is a block diagram illustrating an example of an operational quorum for a five-node cluster with a critical resource.

### DETAILED DESCRIPTION OF THE INVENTION

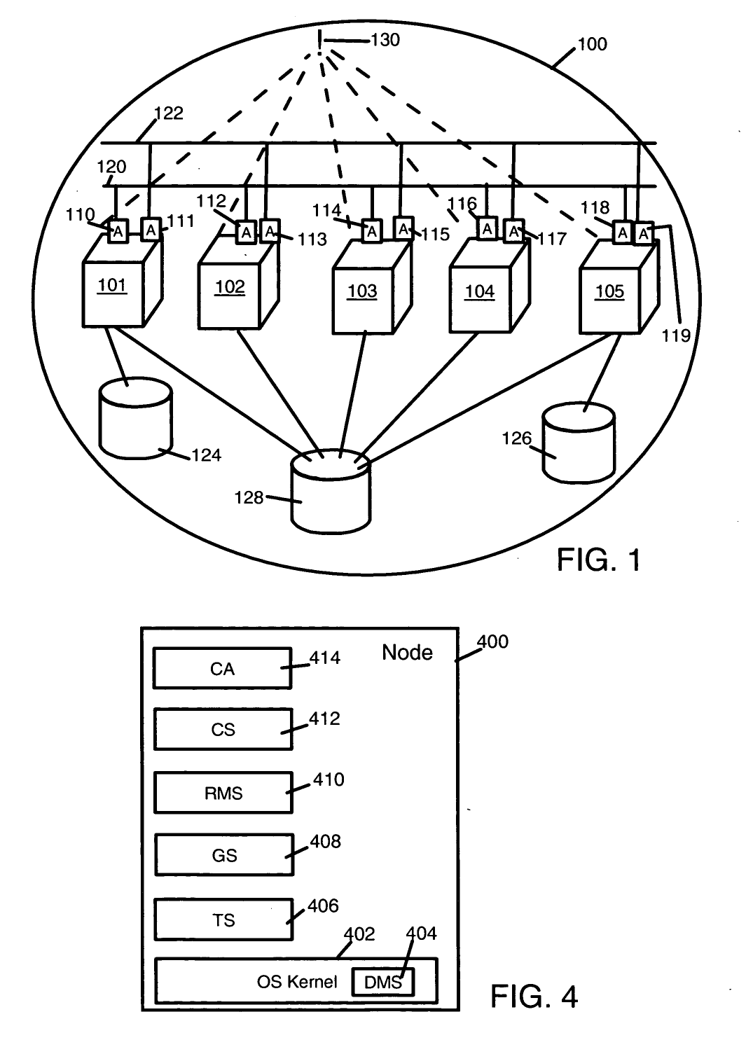

With reference to FIG. 1, there is depicted a block diagram illustrating the hardware components forming a cluster 100. The cluster 100 comprises five nodes 101 to 105. Each node 101 to 105 forms a container hosting an operating system. Such a container may be formed by dedicated hardware, i.e., one data processing system per operating system, or by virtual data processing systems allowing operating a plurality of independent operating systems on one and the same computer system. Furthermore, each node 101 to 105 is equipped with a respective pair of network adapters 110, 111; 112, 113; 114, 115; 116, 117; and 118, 119. One network adapter 110, 112, 114, 116 or 118 of each node 101 to 105 is connected to a first network 120, whereas the other network adapter 111, 113, 115, 117 or 119 is connected to a second network 122.

It is acknowledged that one single network adapter per node and only one network would be sufficient to implement the system and method according to the present invention. However, since the high availability is one of the main targets of the present invention, a redundant network is provided. Alternatively, the networks may have a dedicated purpose, e.g., the first network 120 may be used solely for exchanging service messages between the nodes, whereas the second network 122 may be used as a heartbeat network for monitoring the accessibility of the nodes.

The first node 101 is connected to a resource local to the first node, here a local disk 124. Correspondingly, the fifth node 105 is connected to a local resource, namely a local disk 126 via some communication link. It is acknowledged that each node may have a local disk.

One shared resource, here a shared disk 128, is provided having a communication link to each of the five nodes 101 to 105. The shared disk may form a critical resource as explained in further detail below. It is acknowledged that a shared resource may only be shared amongst a subset of all nodes in within the cluster.

Another object in normal operation accessible by all nodes is a tiebreaker 130. The tiebreaker implements an exclusive lock mechanism, i.e., there are reserve and release operations on the tiebreaker 130, at most one system can reserve the tiebreaker at a time, and only the last system that has the tiebreaker reserved can successfully release the tiebreaker. In case of an error situation, the access to the tiebreaker may be validated through probing operations. In this course, a redundant reservation is permitted. The tiebreaker may be implemented as ECKD DASD (IBM's Extended Count Key Data Direct Access Storage Device) reserve/release, SCSI-2 (Small Computer System Interface) reserve/release, SCSI-3 (Small Computer System Interface) persistent reserve/release, API (Application Programming Interface) or CLI (command line interface) based schemes, a mutual “shoot-out” via STONITH (Shoot The Other Node In The Head from the HA-Heartbeat open source project), or even an always-failing pseudo-tiebreaker, which may advantageously be used during test or with odd-sized clusters only.

With reference to FIG. 2, there is depicted a block diagram of a cluster 200 experiencing a real cluster split. The cluster 200 is configured, i.e., prepared for operation by defining a set of nodes to be potential members of a cluster, and includes five nodes 201 to 205 and one critical resource 210. A resource is ‘critical’ if concurrent access needs to be coordinated in order to avoid harmful operation, e.g., operations that destroy data consistency. The shown cluster 200 is divided into a first active subcluster 212 consisting of nodes 201, 202 and 203, and a second active subcluster 214 consisting of the remaining nodes 204 and 205.

Initially all nodes were able to communicate with each other via a redundant communication network 220. However, in the presented example of cluster 200, the redundant network 220 experiences a malfunction as indicated by symbol 224. As a result, a communication is only possible amongst the nodes of the first and the second active subclusters 212 and 214, respectively; no information can be passed from the first active subcluster 212 to the second active subcluster 214, or vice versa.

In this situation data consistency with regard to the critical resource 210 cannot be ensured and, therefore, only one active subcluster may own the critical resource 210.

A similar severe situation is now described with reference to FIG. 3. There is depicted a block diagram of a cluster 300 having a so-called potential cluster split. Correspondingly to the cluster 200 of FIG. 1, the cluster 300 is configured, i.e., prepared for operation by defining a set of nodes to be potential members of a cluster, and includes five nodes 301 to 305 and one critical resource 310. The shown cluster 300 has got only one active subcluster 312 consisting of nodes 301, 302 and 303. The remaining nodes 304 and 305 are not active. As a result, there is no communication possible between any of the nodes of the active subcluster 312 with any one of the remaining nodes 304 and 305 despite the fact that the redundant communication network 320 is up and running.

From the active subcluster's point of view the potential cluster split shown in FIG. 3 and the real cluster split illustrated in FIG. 2 look the same, i.e., the nodes 301 to 303 and, respectively, the nodes 201 to 203, cannot distinguish a real cluster split from a potential cluster split. As a consequence, changes of the cluster configuration performed during a real cluster split and/or performed during a potential cluster split may lead to an inconsistent cluster configuration. In each case it needs to be ensured that only the nodes of one active subcluster get access to the critical resource 210 (FIG. 2) or 310 (FIG. 3).

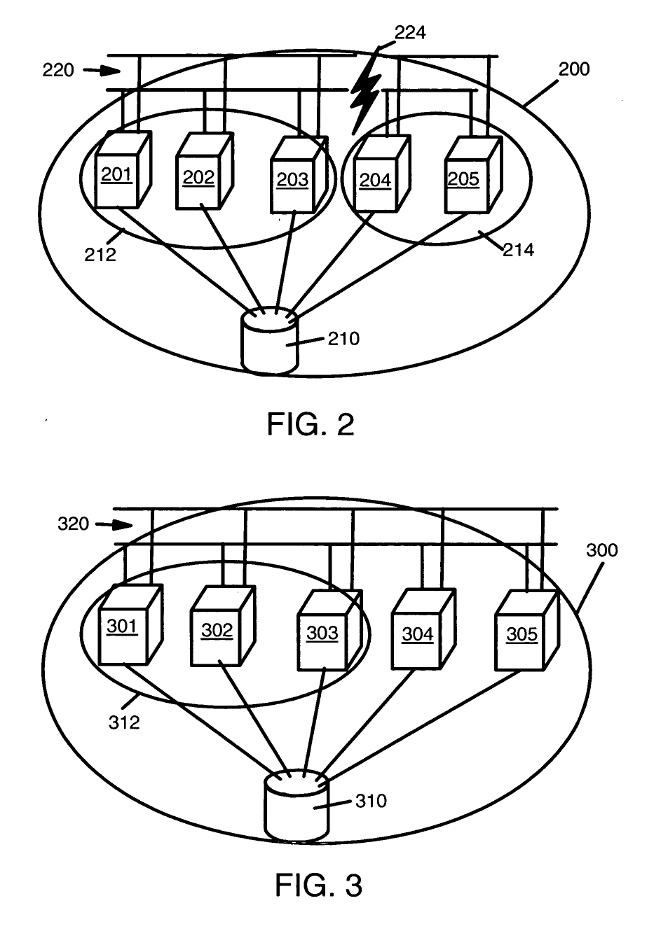

With reference to FIG. 4, there is depicted a detailed block diagram illustrating the cluster's software stack as implemented in each node 400. As aforementioned, a node provides a container for running an operating system, including an operating system kernel 402, i.e., the essential part of the operating systems, responsible for, e.g., resource allocation, low-level hardware interfaces, and security. Preferably, the operating system (OS) kernel 402 is equipped with a so-called dead man switch (DMS) 404. The dead man switch 404 is a precaution mechanism to automatically halt the node if unattended, in order to avoid uncoordinated access to a critical resource. The dead man switch may, e.g., be realized by AIX-DMS (IBM Corporation) or Linux SoftDog.

On top of the OS kernel 402 topology services (TS) 406 are provided. The topology services 406 monitor the physical connectivity between the node on which they are running and other nodes. In doing so, the node gathers information about the nodes being accessible via some physical communication links (not shown). RSCT Topology Services (IBM's Reliable Scalable Clustering Technology Topology Services) or HA-heartbeat (an open source high-availability project) may implement the topology services.

The next layer is formed by group services (GS) 408, which allow creating logical clusters of processes and include group coordination services. RSCT Group Services provide an implementation of the group services.

One layer up, there are the resource management services (RMS) 410, which control resources, such as adapters, file systems, IP addresses and processes. The RMS may be formed by RSCT RMC and RMgrs (IBM's RSCT Resource Management and Control and Resource Managers), or CIM CIMONs (Common Information Model).

The next layer is formed by cluster services (CS) 412 responsible for representing subclusters of active nodes and providing configuration and quorum services, which will be explained below in further detail. RSCT ConfigRM (IBM's RSCT Configuration Resource Manager) implements the functionality of the cluster services.

All those layers form the cluster infrastructure on which a cluster application (CA) 414 can operate that is in fact distributed over a plurality of nodes, such as GPFS, SA for Linux, Lifekeeper, or Failsafe.

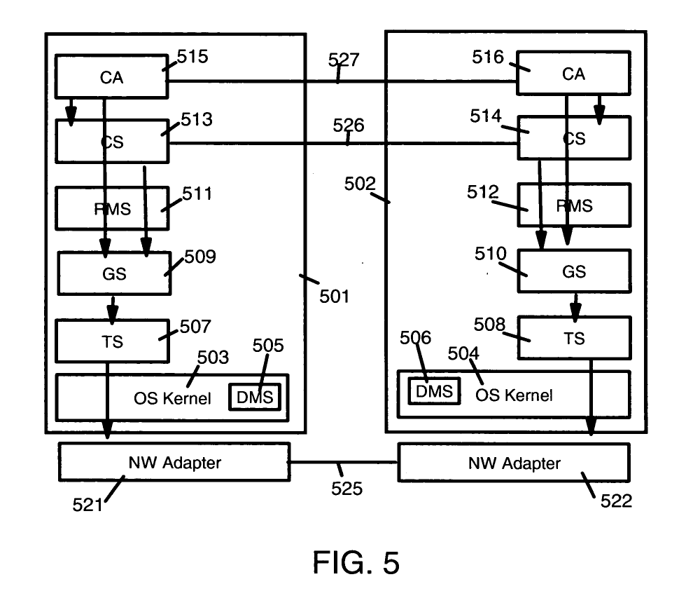

With reference to FIG. 5, there is depicted a block diagram illustrating software and hardware layers of a first node 501 and a second node 502 together with their accessibility and potential failure points. Each node comprises the different layers as described with reference to FIG. 4, namely an OS kernel 503, 504, including the DMS 505, 506, a TS layer 507, 508, a GS layer 509, 510, an RMS layer 511, 512, a CS layer 513, 514 and a CA layer 515, 516. Each node 501, 502 is connected to a respective network adapter 521, 522, which in turn is connected to a physical communication link 525 between the nodes.

The topology services 507, 508 monitor the operation of the physical communication link provided by the network adapters 521, 522. The group services establish and monitor the logical cluster of nodes (line 526) and the logical cluster of the cluster application (line 527).

During the operation of a cluster several possibilities of node accessibility failures exist, which all need to be detected in order to initiate the right measures. A CA failure is observed and treated by a remote CA instance on a different node based on information provided by GS. A CS failure is observed by all local services and applications that need information about currently accessible nodes and/or changes in the cluster configuration. A CS layer of a remote node observes this as a node failure based on information provided by GS.

In case the GS fail, all local CAs and CS will observe it. A remote GS will observe this failure as a logical node failure.

When the TS fails, the local GS will observe it as a fatal error or as an isolation of the node. Remote TS observe this as a node accessibility failure. The same happens when the node fails due to an OS kernel failure, when all network adapters of a node fail or when all networks between two nodes fail themselves. The information about an observed failure will be propagated from TS to GS and from GS to CS, RM and CAs, respectively.

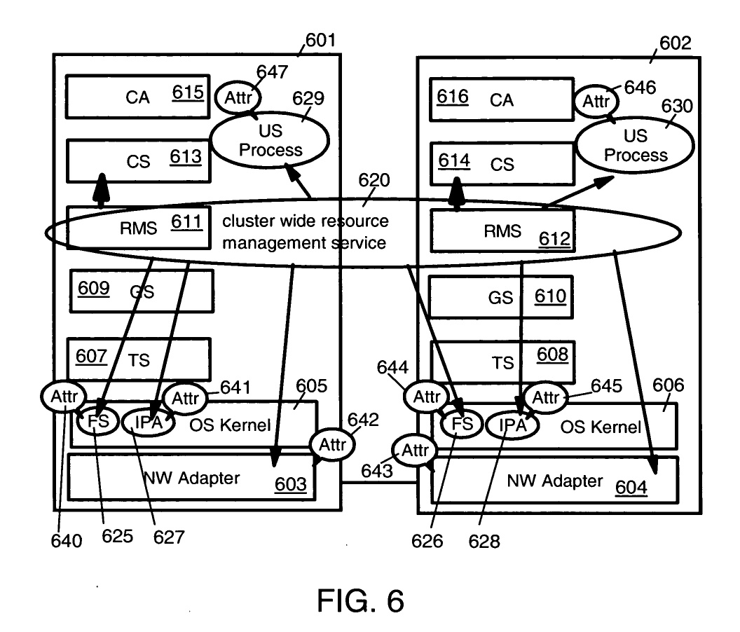

With reference to FIG. 6, there is depicted a block diagram of a first and a second node 601, 602 illustrating the functionality of a cluster-wide resource management service. Each node comprises the different layers as described with reference to FIG. 4, namely a network adapter 603, 604, an OS kernel 605, 606, a TS layer 607, 608, a GS layer 609, 610, a RMS layer 611, 612, a CS layer 613, 614 and a CA layer 615, 616. Network adapters 603 and 604 provide a physical communication link between the nodes 601 and 602.

The cooperation of the resource management services (RMS) 611, 612 on each node form a cluster-wide resource management service as illustrated by the line 620 enclosing the RMS 611, 612 of the first and second node 601, 602. The cluster-wide RMS manages, i.e., starts, stops, monitors, a plurality of resources, such as file systems 625, 626, IP addresses 627, 628, user space processes 629, 630 and the network adapters 603, 604 as indicated by the respective arrows. In order to coordinate the cluster-wide resource management with the actual cluster state and configuration, the cluster-wide RMS consults the cluster state from the cluster services, as indicated by the respective arrows. Additional information used for the cluster-wide resource management is derived from resource attributes 640 to 647 assigned to each of the plurality of resources. The attributes may provide information about the environment in which a resource may be started, the resource's operational states, or whether or not it is critical.

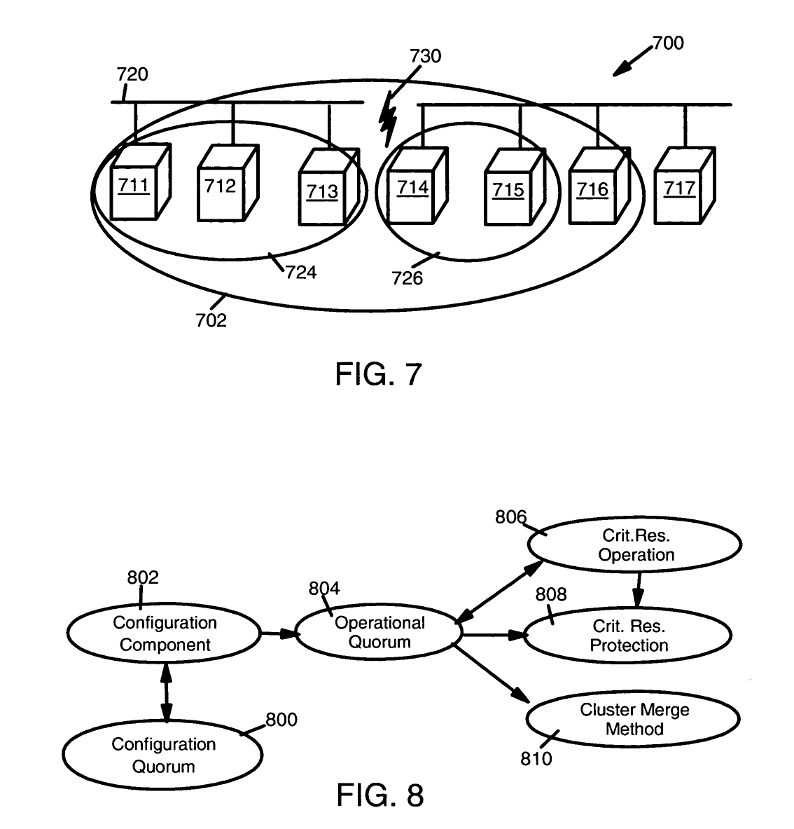

With reference to FIG. 7, there is depicted a block diagram of a computer system 700 illustrating the operation of a configured cluster 702. The computer system 700 includes seven nodes 711 to 717. All nodes are able to communicate with each other via a communication network 720. Six nodes 711 to 716 are defined to be a potential member of a cluster and, therefore, those nodes form the configured cluster 702. One of the nodes 711 to 716 forming the configured cluster, namely node 716, is offline, either because it was shut down or due to a failure. Because of this state, node 716 cannot take part in an active subcluster.

The remaining nodes 711 to 715 are online, i.e., up and running, and they form two disjoined active subclusters, namely a first and a second active subcluster 724, 726. Three nodes, namely nodes 711 to 713, form the first active subcluster 724 and two nodes, namely node 714 and 715, form the second active subcluster 726. The separation of the two active subclusters was caused by a complete network failure between nodes 713 and 714 as illustrated by symbol 730. Generally speaking, an active subcluster is formed by a set of online nodes in a configured cluster that are able to communicate with each other and that are mutually be aware of belonging to a common cluster.

“N” denotes the size of the configured cluster, in the present case N=6. “k” denotes the size of an active subcluster in focus. In FIG. 7, the first active subcluster 724 has got a size of k=3 and the second active subcluster 726 has got a size of k=2.

When referring to an active subcluster the following properties are defined, “majority”, “tie” and “minority.” An active subcluster has got a majority when k>N/2, an active subcluster is in a tie when k=N/2, and an active subcluster has got a minority when k<N/2. In FIG. 7, the first active subcluster 724 is in a tie, whereas the second active subcluster 726 has got a minority.

In order to safely operate a cluster, the present invention introduces several components, which may be implemented as part of the CS, RMS, GS and/or TS. The provided components implement safe methods for operating a cluster even in the case of node or network failures.

With reference to FIG. 8, there is depicted a flow chart illustrating the information flow among cluster components. The first component 800 determines a configuration quorum. Using the configuration quorum allows one to update the cluster configuration in a consistent way despite node or network failures. Preferably, this component gets implemented as part of the cluster services.

A configuration component 802 uses information of the configuration quorum 800 to decide whether updates to the configuration are admissible. On the other hand, the configuration quorum 800 needs information on the current configuration stored in one or more nodes to determine the configuration quorum.

Based on the information of the configuration component 802, the next component 804 generates an operational quorum. The operational quorum determines whether or not a critical resource may run. Preferably, this component gets implemented as part of the cluster services, too.

A critical resource operation component 806 determines critical resources and restricts their operation according to the operational quorum. This component is preferably implemented as part of the resource management services. A critical resource protection component 808 is configured to protect critical resources against harm in case that the operational quorum gets lost. This component is preferably implemented as part of one of the following units, CS, RMS, GS and TS, whereby information from the respective others may be required.

Finally, a cluster merge component 810 is provided, realizing a method for merging and splitting clusters while preserving the operational quorum and the critical resources. This component is preferably part of the group services. After this brief overview of the single components, the detailed operation of the components is explained in the following.

The configuration quorum component advantageously allows updates of the cluster configuration even though not all nodes of the configured cluster form a single active cluster or subcluster in a way that leaves the cluster definition consistent. The cluster configuration is a description of the configured cluster (and arbitrary attributes) that needs to be stored on every node of the configured cluster. The cluster configuration, which may be stored in a file, contains at least the following information: a list of all nodes belonging to the configured cluster and a timestamp of the latest update of this copy of the configuration.

In order to achieve the goal, the configuration quorum component is configured to perform the following operations that are described in more detail below: setting up (configuring) the initial cluster, starting a node or a set of nodes, adding a node to the configured cluster, removing a node from the configured cluster, and other configuration updates. Consistency of the cluster configurations can be ensured only if only these operations (without quorum overriding options) are used to initialize and modify the cluster configuration.

According to the present invention the following method is performed in order to initialize a cluster. First, N nodes Sl-SN are selected to form a cluster. This information is stored in a cluster configuration file having a current timestamp. The cluster configuration file is locally available on each of the nodes Sl-SN. Preferably the cluster configuration file is sent to all nodes Sl-SN and stored there. Alternatively, the cluster configuration files are stored on a distributed/shared file system accessible by all nodes. Subsequently, it is determined whether a majority of the nodes Sl-SN are able to access the cluster configuration file. If yes, then a message is generated informing the user or administrator of the cluster that the cluster set-up was successful. If no, then it is attempted to undo the configuration and a message is generated informing the user that the cluster configuration may be inconsistent.

According to the present invention the following method is performed in order to start a node. First, an up-to-date cluster configuration file is searched for. If an up-to-date cluster configuration file is found, then it is determined whether or not the node to be started is a member of the cluster defined in the cluster configuration file. If yes, then the node is started as a node of the cluster defined in the cluster configuration file. If no up-to-date cluster configuration file is found or if the node to be started is not part of an up-to-date cluster configuration, then the node is not started and a corresponding error message is generated.

The first step of searching for an up-to-date cluster configuration file is performed as described in the following. At first, a locally accessible cluster configuration file is used as a working configuration file, which is, for the time being, considered the up-to-date cluster configuration file. Then, all nodes listed in the working configuration file are contacted and asked for their local cluster configuration file. In case a cluster configuration file received from one of the contacted nodes is a more recent version than the working configuration file, then the more recent version becomes the working configuration file. These steps are repeated until the working configuration file does not change anymore. Subsequently, it is determined how many of the contacted nodes have a (possibly outdated) cluster configuration file. If at least half of the nodes listed in the working configuration file have a cluster configuration file, then the working configuration file is an up-to-date cluster configuration file; else the up-to-date definition remains unknown.

According to the present invention the following method is performed in order to add a set of j nodes to an active subcluster, whereby N is the size of the configured cluster and k is the size of the active subcluster. It is acknowledged that a node in an active subcluster performs this method.

When a request for adding a set of j nodes to a configured cluster is issued, then it is determined whether or not the following condition is satisfied or not. Namely, if 2k<N or 2k<N+j, then an error message is generated informing the user that the requested operation would cause inconsistent cluster configuration. In other words, if the number of nodes in the active subcluster is only half of the number of nodes in the configured cluster or less, or if the number of nodes to be added will lead to a new cluster in which the active subcluster does not provide at least half of the nodes, adding of the new nodes is not allowed.

Optionally, the connectivity to the nodes to be added may be checked at this point and in case that one or more nodes cannot be reached, the set of nodes to be added may be adjusted according to the result of the connectivity check.

After determining that the nodes can safely be added to the cluster, the new configuration is transactionally, i.e., in a safe, atomically co-ordinated way, propagated to all nodes in active subcluster. Additionally, the OpQuorum gets informed about the change of the cluster configuration.

Then, the new cluster configuration is copied to offline nodes (i.e. to the nodes not in the active subcluster), including the new nodes that were added. Finally, a list of successfully added nodes is returned.

According to the present invention the following method is performed in order to remove a set of j nodes from a cluster configuration, whereby N is the size of the configured cluster and k is the size of the active subcluster. It is acknowledged that a node in an active subcluster performs this method and the node to be removed must be offline.

When a request for removing a set of j nodes from a configured cluster is issued, then it is determined whether or not the following condition is satisfied. Namely, if 2k<N, then an error message is generated informing the user that the requested operation would cause an inconsistent cluster configuration. In other words, if the number of nodes in the active subcluster is less than half of the number of nodes in the configured cluster, removing of nodes is not allowed.

Optionally, the connectivity to the nodes to be removed may be checked at this point and in case that one or more nodes cannot be reached, the set of nodes to be removed may be adjusted according to the result of the connectivity check.

After determining that the requested nodes can safely be removed from the cluster, the configuration is removed from all nodes to be removed. In case this step is not successful and 2k=N, then an error message is returned to inform the user that the requested operation would cause an inconsistent cluster configuration.

If the configuration could be removed from the nodes to be removed, the new configuration is transactionally propagated to all nodes in active subcluster. Additionally, the Operational Quorum gets informed about the change of the cluster configuration.

Then, the new cluster configuration is copied to offline nodes that remain in the cluster. Finally, a list of successfully removed nodes is returned.

According to the present invention the following method is performed in order to introduce other configuration updates, whereby N is the size of the configured cluster and k is the size of the active subcluster. It is acknowledged that a node in an active subcluster performs this method.

When a request for another configuration update is issued, then it is determined whether or not the following condition is satisfied. Namely, if 2k<N, then an error message is generated informing the user that the requested operation would cause an inconsistent cluster configuration. In other words, if the number of nodes in the active subcluster is less than or equal to half of the number of nodes in the configured cluster, introducing other configuration changes is not allowed.

After determining that the requested update to the configuration can safely be introduced, the new cluster configuration is transactionally propagated to all nodes in active subcluster. Then, the new cluster configuration is copied to offline nodes. Finally, a list of nodes is returned on which the requested modification to the cluster configuration has been successful.

According to the present invention the quorum for removing nodes can be overwritten, the quorum for starting nodes can be overwritten, and the administrator of the cluster can provide a new cluster definition. Overwriting the configuration quorum may be needed in order to resolve failure situations, in which at least half of the cluster has failed or is not accessible. Overriding the quorum results in a loss of the guarantee that the cluster definition will be consistent.

Now the operation of the operational quorum (OpQuorum) component is described in detail. Generally, the following information may be accessed from each online node: the size N of the configured cluster, the size k of the active subcluster the node is in and whether or not critical resources are running on the node. The operational quorum component is, therefore, configured to receive information about changes of the size N of the configured cluster, about changes of the size k of the active subcluster the node is in, and about changes regarding critical resources. Preferably, the group services provide the information about the nodes in an active subcluster, whereas the resource management services provide information about critical resources.

According to the present invention the operational quorum component may access the following services, a tiebreaker (only needed for even-sized cluster configurations), transaction support, which is preferably be provided by the group services, and a group leadership. The group leadership is characterized by each active subcluster having a group leader, which gets re-evaluated upon any change of the subcluster configuration; this is preferably provided by the group services.

Furthermore, the operational quorum component provides a state of the operational quorum as observed on the node. The state may be one of the following values, in_quorum, quorum_pending and no_quorum.

According to the present invention the operational quorum component determines the state according to the following method, whereby the state gets determined right after bringing the node online and it is re-evaluated upon every change of the configured cluster and every change of the active subcluster the node is in. Initially, the state is no_quorum.

Firstly, the values for N, i.e., the size of the configured cluster, and k, i.e., the size of the active subcluster, are retrieved. Then it is determined which of the conditions 2k<N, 2k=N or 2k>N is true. In case the condition 2k<N is true, it is determined, whether or not the node has the tiebreaker reserved and, if yes, the tiebreaker is released. Additionally, the state is set to no_quorum and a resource protection function is triggered, if the node has critical resources online.

In case the condition 2k=N is true, the OpQuorum state is set to quorum_pending, and a reservation of the tiebreaker is requested. If the tiebreaker reservation is successful, then the OpQuorum state is changed to in_quorum, else if the reservation is undetermined continue with the step of getting the values of N and k above, or return, if this method was initiated asynchronously by a change of the cluster configuration or the size of the active subcluster.

If the tiebreaker reservation is not successful, then the OpQuorum state is set to no_quorum and if the node has critical resources online, a resource protection function is triggered. If the node does not have critical resources active (or online), the OpQuorum state is set to quorum_pending and the node will try to reserve the tiebreaker periodically, or the OpQuorum state is set to no_quorum and it is re-evaluated periodically as long as the tie situation persists.

In case the condition 2k>N is true, it is determined whether or not the node has the tiebreaker reserved and, if yes, the tiebreaker is released. Additionally, the OpQuorum state is set to in_quorum.

It is acknowledged that the method to compute OpQuorum is called right after the start of a node (as result of being integrated in the cluster) and whenever a change of either the cluster configuration or the current subcluster the node is part of occurs.

According to the present invention the tiebreaker is configured to provide the following functionality, namely, initializing, locking, unlocking and heart-beating.

The initialize tiebreaker or probe tiebreaker function allows to initialize the tiebreaker on a node. Locking the tiebreaker provides the functionality, that at most one node can successfully lock (reserve) the tiebreaker. In case the tiebreaker is persistent, i.e., it keeps the fact of being locked or not as a state, a locked tiebreaker cannot be unlocked by a node that does not own the lock. The unlocking operation provides the functionality that only the last node that successfully locked the tiebreaker can successfully unlock (release) the tiebreaker. For a non-persistent tiebreaker, such as a software interface or STONITH based tiebreakers, this operation may be implemented as a NOP (no operation), i.e., an empty function.

The heartbeat tiebreaker function allows to repeatedly lock the TB. This advantageously gets implemented, if persistence of the tiebreaker cannot be guaranteed. As an example, certain disk locking locks may be lost if the bus is reset.

The implementation of the initialization of the tiebreaker, the locking and unlocking of the tiebreaker may be different depending on the kind of tiebreaker used. Preferably the tiebreaker gets implemented as an object oriented class with respective instances.

According to the present invention the reservation of the tiebreaker is performed according to the following method.

First, it is determined whether or not the tiebreaker has already been initialized. If yes, subsequent actions may be performed. If no, the initialization function gets executed. In case the size of the configured cluster or active subcluster changed while the node has quorum_pending and is competing for the tiebreaker, a message gets returned informing that the tiebreaker is undetermined.

If the tiebreaker is initialized and a node requesting to reserve the tiebreaker is the group leader in an active subcluster, then it is determined whether or not the tiebreaker is reserved by this node (due to a failure in releasing the tiebreaker previously). If yes, then stop a potential thread trying to release the tiebreaker. If no, then lock the tiebreaker. In any case, the result gets broadcasted to all nodes of the active subcluster. In case the tiebreaker is of the non-persistent type, heart-beating is started.

If the tiebreaker is initialized and a node requesting to reserve the tiebreaker is not the group leader in an active subcluster, then wait for group leader's result. If the size of the configured cluster or active subcluster changed while the node has quorum_pending and is competing for the tiebreaker, then return undetermined, else return group leader's result.

According to the present invention the following method is performed in order to release the tiebreaker. If the tiebreaker is of the non-persistent type then stop tie-breaker heart-beating. Then unlock the tiebreaker by initiating the respective functionality. If unlocking of the tiebreaker has failed, then the node will repeatedly try to unlock the tiebreaker asynchronously from the other thread of the execution. The result is returned.

According to the present invention heart beating a non-persistent tiebreaker is performed as defined in the following method. First, the tiebreaker is locked, then after waiting for a predefined time span locking of the tiebreaker is repeated. These steps are executed as long as the tiebreaker should be kept locked.

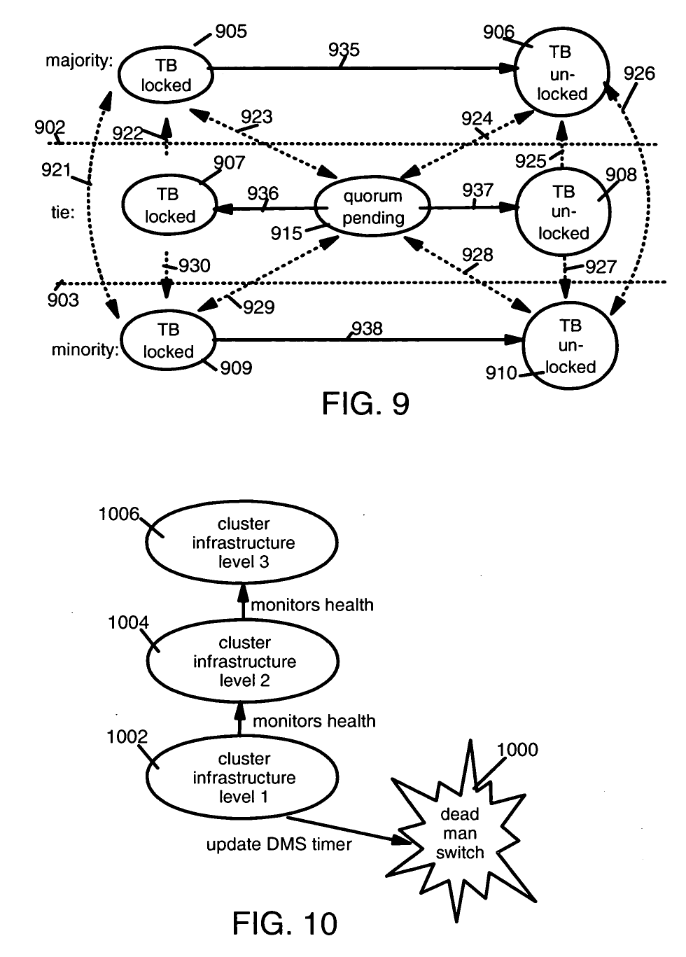

Above the environment, the components, the different mechanisms and states of the nodes according to the present invention have been described. The change of operational quorum states of a particular node is now summarized with reference to FIG. 9. There is depicted a state diagram illustrating different operational states of the single node. The state diagram is horizontally divided in three portions, separated by dotted lines 902, 903. Depending on the circumstance, i.e., the fact whether the node is part of an active subcluster having the ‘majority’, ‘minority’ or being ‘in tie’, the top portion (above line 902), the bottom portion (below line 903) or the middle portion (between line 902 and line 903) needs to be addressed, respectively. In each circumstance, the tiebreaker may be locked or unlocked as illustrated by the states (blocks 905 to 910). In case of the node being part of an active subcluster being in tie, there is another state, namely the quorum pending state (block 915). States 905, 906, 907 are in OpQuorum state in_quorum. States 908, 909, 910 are in OpQuorum state no_quorum.

The dotted lined arrows 921 to 930 denote the change of the state when the circumstance, i.e., ‘majority’, ‘minority’ or ‘in tie’, changes due to a change of the size of the respective active subcluster or the size of the defined cluster.

The solid arrows 935 to 938 denote state transitions initiated whenever the respective source state is active, e.g., if the node has got the tiebreaker locked and it is part of an active subcluster having the majority (block 905) then the node releases the tiebreaker immediately (transition 935). Once the tiebreaker is unlocked the target state 906 is reached. Correspondingly, the state 909 changes to state 910 as indicated by transition 938. From the quorum pending state 915, either state 907 (via transition 936) or state 908 (via transition 937) is reached, depending on the fact whether or not the node could lock the tiebreaker.

Returning to the issue of critical resources. Generally, resources are managed by a resource manager (RM), which associates attributes to each resource, e.g., the locations where the resources may be started, the operational status (online or offline), and the methods to start/stop/monitor the resource.

According to the present invention a Boolean attribute ‘is_critical’ is associated to each resource, whereby the attribute being True, if the resource is critical, and False, if the resource is not critical. The attribute ‘is_critical’ is set to False, if more than one independent node (here independent means that the nodes cannot communicate to each other) can keep the resource online without causing any harm. In all other cases, the attribute ‘is_critical’ must be set to True.

Preferably, the attribute is preset to a particular value, i.e., True or False, depending on the resource, in the RMS component. Alternatively, it may be configurable on per resource class or per resource basis. It is acknowledged that it is safe to use is_critical=true as default. Furthermore, it must be possible for an online node to run without critical resources. Preferably, on each node the RMS component or the CS component maintains a counter of the online resources running on that node having the attribute is_critical set to True. The following operations are affected by the is_critical attribute, namely, start resource, stop resource, change attribute is_critical, and resource failure detection.

According to the present invention on each node that is online, an online critical resource count (OCRC) is maintained. The OCRC counts the number of resources being online and having the is_critical attribute set to True, which are running on the respective node. Preferably, the OCRC is implemented as part of the cluster services (CS). The cluster services are configured to increment and decrement the OCRC in response to all resource managing applications, in particular, in response to the resource management services (RMS). Furthermore, the OCRC is made available to any other cluster software (component).

The OCRC is operated according to the following method. Whenever the OCRC drops to 0, the resource protection will be disabled on that node, and whenever the OCRC changes to a positive number (>1), the resource protection will be enabled on that node. This advantageously guarantees resource protection whenever a critical resource is running on the particular node.

According to the present invention a resource is started on a node according to the following sequence of operation. If the resource has the attribute is_critical set to True then wait until the OpQuorum reaches a state other than ‘quorum_pending.’

Subsequently if the OpQuorum is set to ‘no_quorum’, then an error message is returned notifying the user about the failure (reason: no_quorum). Subsequently the OCRC is incremented on node S (this may trigger the enabling of the resource protection) Finally the resource start method is called on node S.

Correspondingly, a resource is stopped on a node S when the resource stop method is called on node S. If the resource has the attribute is_critical set to True then the OCRC is decremented on S (this may trigger the disablement of the resource protection).

When a resource failure is detected on a node, namely, if the resource monitoring detects a failure of a resource on a node S, then, if the resource has the attribute is_critical set to True, the OCRC gets decremented; this may trigger the disablement of the resource protection.

According to the present invention a change-attribute-is_critical-method gets called upon initialization and with every change of the value of is_critical for resource R. If the (new) value is false, then on all nodes in the active subcluster where R is online the OCRC is decremented by the multiplicity of the instances of R online on each of those node. If the (new) value is true, namely, if all nodes where R is online have OpQuorum in_quorum, then the OCRC gets incremented on all those nodes by the multiplicity of the instances of R online on each of those nodes, else a failure message is returned (reason not in_quorum).

Cluster software that does not use an explicit RMS layer may protect the (critical) resources it manages by using resource start/stop/failure detection in the same way as the RMS; the knowledge of whether a managed resource is critical or not may be hard-coded in the software.

Advantageously, the resource protection protects a critical resource that is online on a node from causing any harm in case the active subcluster, to which the node belongs to, has its OpQuorum equals to noquorum; in this case the resource protection method gets processed. In case the node “hangs”, i.e., does not respond, or the cluster infrastructure misbehaves, system self-surveillance may be used, as described below.

The following operations are needed to implement the resource protection mechanism. First there are resource protection trigger. A resource protection trigger operation may be one of the following functions: (1) halt the system ungracefully; (2) halt the system gracefully; reboot the system (after graceful halt); (4) reboot the system (after ungraceful halt); or (5) do nothing (i.e. leave resource protection to other components).

Which of the above functions is actually used to trigger resource protection is configurable by the administrator. Preferably the “trigger halt ungracefully” or “reboot the system after an ungraceful halt” should be used in production systems, while the other methods may be used for test purposes.

Second, there is an operation to enable resource protection by activating the DMS.

Third, there is an operation to disable resource protection by deactivating the DMS

With reference to FIG. 10, there is depicted a flow chart illustrating the dependencies of the systems self-surveillance. According to the present invention, on each node one Dead Man Switch 1000 (DMS) monitors the entire cluster infrastructure of that node. Cluster infrastructure level 1 (block 1002) updates directly the DMS 1000. An active DMS requires timer updates on a regular basis otherwise it stops the kernel operation. According to the presented concept, monitored results are propagated from higher to lower cluster infrastructure levels. In other words, cluster infrastructure level 1 (block 1002) monitors the health of cluster infrastructure level 2 (block 1004), and cluster infrastructure level 2 (block 1004) monitors the health of cluster infrastructure level 3 (block 1006). Typically Cluster infrastructure level 1 will be topology services (TS), level 2 will typically provide group services (GS) and level 3 will provide cluster services (CS). It is acknowledged that this concept is not limited to three cluster infrastructure levels. This scheme of stacked monitoring allows for using DMS implementations which only allow monitoring one single application (client). Hence, defective or hanging cluster infrastructure components from any level will prevent monitor signal propagation and, therefore, will trigger the DMS that, in return, will stop the kernel operation.

The topology services component (TS) is the layer that accesses the DMS directly. Blockage or failure in the topology services component results in the kernel timer being triggered and the node halting. The group services component (GS) does not access the DMS directly, but instead sets itself to be monitored by the topology services component. Being already a client program of the topology services component, the group services component gets monitored by the topology services component by invoking a given topology services component client function. If the group services component fails to call the client function on a timely basis then an internal timer is allowed to expire in the topology services component. The action taken by the topology services component is to terminate the execution of the cluster on the node, based on the specific resource protection method. Because the group services component only has severe real-time requirements while processing node events passed to it by the topology services component, the group services component will only be required to invoke the new function on a timely fashion after getting a node event from the topology services component.

The internal timer in the topology services component is thus only set right before the topology services component sends any node accessibility event to the group services component. The latter needs to react to the event by invoking the new client function as soon as the node accessibility event has its handling completed.

The cluster services component is a client of the group services component, with the group services component providing group coordination support to allow the cluster services component peer daemons to exchange data and coordinate recovery actions. The group services component is also used to monitor the cluster services component for blockage/termination. Termination is detected via monitoring of the Unix-Domain socket used for communication between group services component and its client programs. Blockage is detected by a “responsiveness check” mechanism that has the group services component client library invoke a call-back function in the cluster services component. Failure of the call-back function to return in a timely manner results in the group services component daemon detecting blockage in the cluster services component. In both cases, the group services component reacts by exiting, which results in the topology services component invoking the resource protection method.

The aforementioned monitoring chain advantageously guarantees that, if any fundamental subsystem gets blocked or fails, a resource protection method is applied, which causes the critical resource to be released.

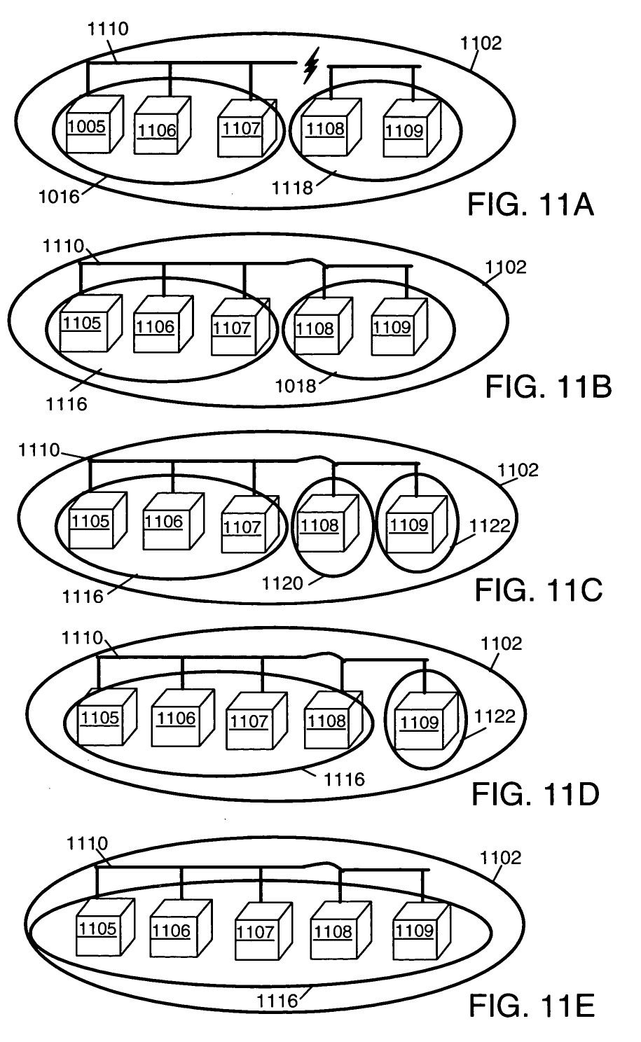

Now the operation of a cluster in accordance with the present invention will be explained with reference to FIG. 11a to 11e. All figures show the same configured cluster 1102 comprising five nodes 1105 to 1109 and a network 1110. The active subclusters and their mode of operation, however, may change from Figure to Figure.

With reference to FIG. 11a, there is depicted a block diagram of the configured cluster 1102 having a cluster split situation, because the network 1110 is broken between nodes 1107 and 1108. The network split creates a first active subcluster 1116 comprising the nodes 1105 to 1107 and a second active subcluster 1118 comprising the nodes 1108 and 1109.

With reference to FIG. 11b, there is depicted a block diagram of the configured cluster 1102 in which the connectivity has been re-established between nodes 1107 and 1108. However, there are still the two active subclusters 1116 and 1118. According to the present invention, first one of the two active subclusters is dissolved, before merging begins. The decision, which of the two active subclusters gets dissolved, is determined in accordance with the following set of rules:

1. If only one subcluster has the OpQuorum by being majority or being in a tie having the tie breaker then the subcluster not having the quorum dissolves.

2. If the subcluster definitions differ then the subcluster with the older cluster definition dissolves.

3. If only one subcluster runs critical resources then the subcluster that does not run critical resources dissolves.

4. If the subcluster differ in size, then the smaller subcluster dissolves else.

5. A random (e.g. the one with the smallest online node number) subcluster dissolves.

The above rules are ordered by their priority from high priority to low priority.

As it can be seen in FIG. 11c, the second active subcluster has been chosen to be dissolved. There is depicted a block diagram of a cluster being in merge phase 1, namely, in the phase of dissolving one subcluster. Now, there is the initial first active subcluster 1116 and two new active subclusters 1120 and 1122, including node 1108 and 1109, respectively.

Now, with reference to FIG. 1I d, there is depicted a block diagram of a cluster being in merge phase 2, namely, in the phase of the first node joining. The nodes of the dissolved cluster join the non-dissolved cluster one by one adopting the cluster configuration of the non-dissolved active subcluster. Now, the first active subcluster 1116 comprises the nodes 1105 to 1108.

With reference to FIG. 11e, there is depicted a block diagram of a cluster being in merge phase 3, namely, in the phase of the second node forming active subcluster 1122 joining the first active subcluster 1116. Finally, the first active subcluster 1116 comprises nodes 1105 to 1109.

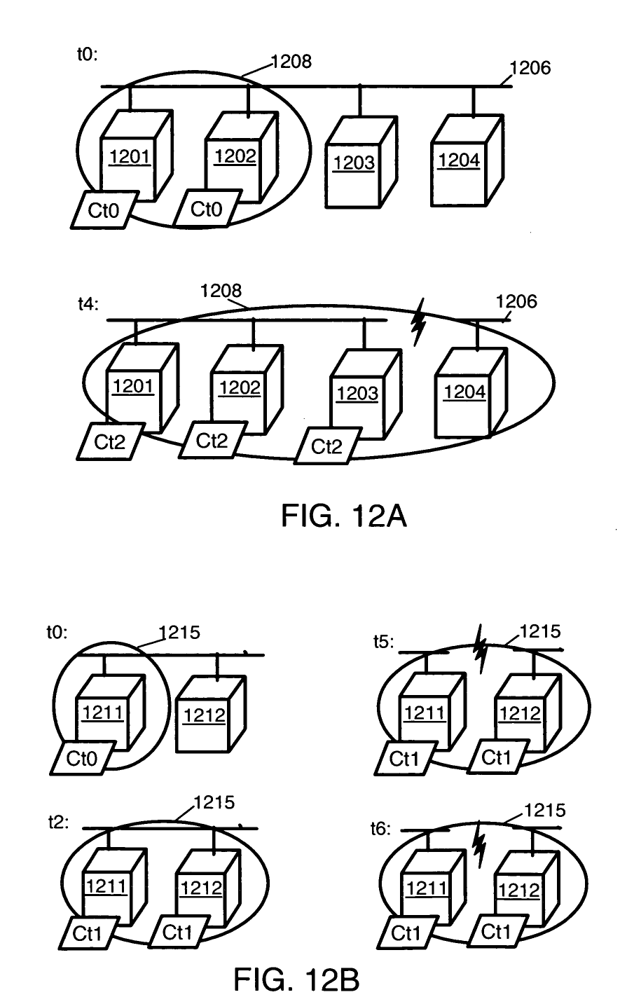

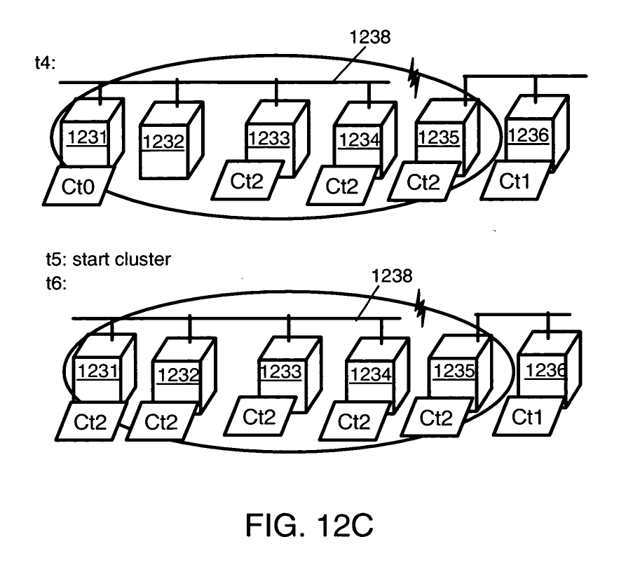

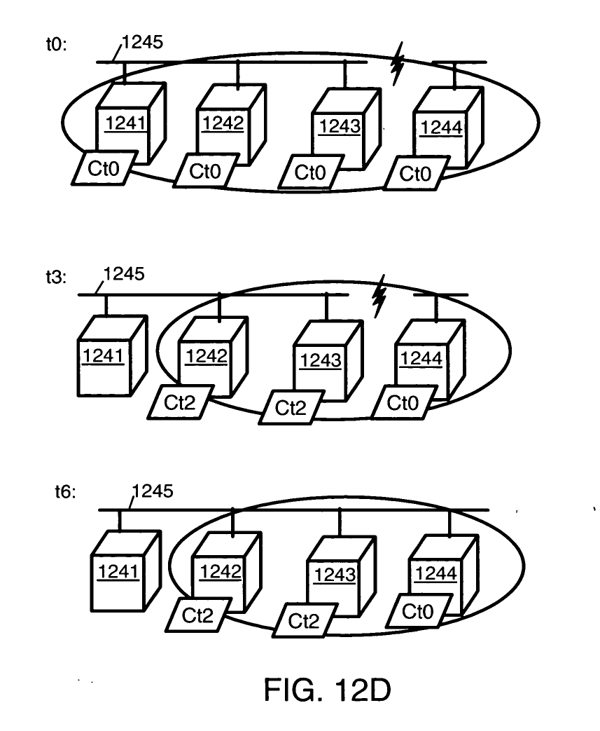

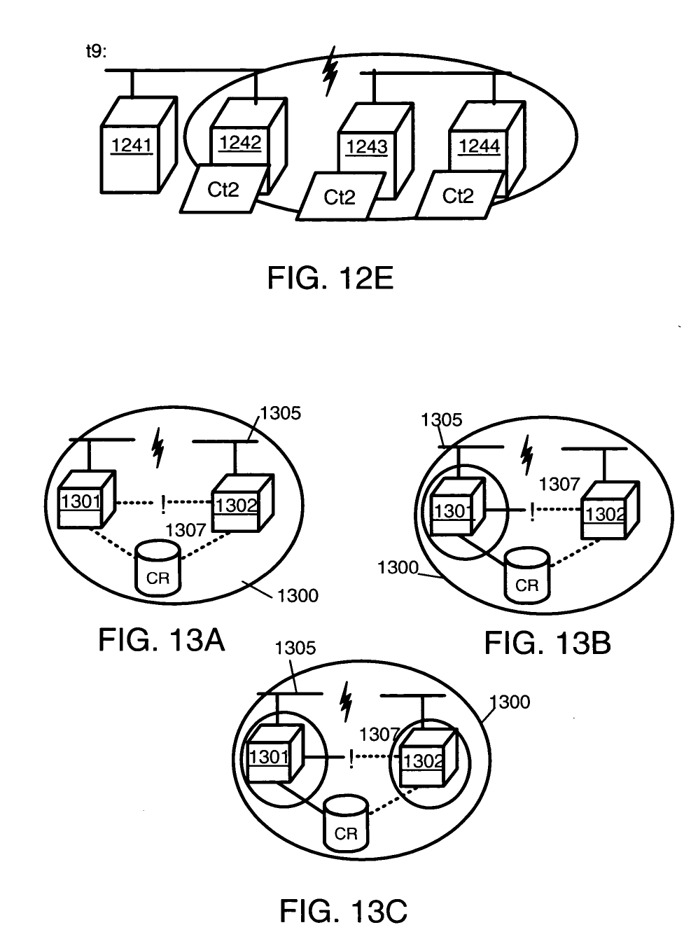

With reference to FIGS. 12a-e, there are depicted block diagrams illustrating examples of the configuration quorum. FIG. 12a shows a situation where four nodes 1201 to 1204 are connected via network 1206. At time t0 the network is in order and nodes 1201 and 1202 are up, whereas nodes 1203 and 1204 are down. A cluster with definition Ct0 has been configured. Ct0 contains nodes 1201 and 1202. Hence nodes 1201 and 1202 build a cluster 1208.

At time t1 the nodes 1203 and 1204 are added to the cluster. At time t2 the node addition has reached the point where the cluster definition has been updated on nodes 1201 and 1202 to Ct2 containing nodes 1201 to 1204. At time t3 a network failure isolates node 1204 from the rest of the cluster.

The situation at time t4 is shown in FIG. 12a, too. Once the node addition operation has finished, nodes 1201 to 1203 are up and form a cluster. Each of the nodes 1201 to 1203 has the cluster definition Ct2. The node S4 is down and does not have a cluster definition.

FIG. 12b shows two nodes 1211 and 1212 at four different points of time, t0, t2, t5 and t6. At point of time t0 the respective configuration Ct0 contains solely node 1211, forming the cluster 1215. Initially, node 1211 is online while node 1212 is offline. At point of time t1, node 1212 is added to the cluster, whereby the new cluster definition Ct0 containing nodes 1211 and 1212 is present at each node as depicted in FIG. 12b, t2.

Later, at point of time t3 node 1211 gets stopped, so that both of nodes 1211 and 1212 are offline. Then, at point of time t4 a network failure occurs in network 1218. Now both nodes 1211 and 1212 are down; however, the cluster configuration of both nodes is up-to-date, as depicted in FIG. 12b, t5. At point of time t6 node 1212, which was previously offline, gets started and is now online.

FIG. 12c shows six nodes 1231 to 1236 at two different points of time, t4 and t6. All nodes are connected to a network 1238 that experiences a network failure between nodes 1234 and 1235. Node 1231 has got a configuration Ct0, which was up-to-date at a previous point of time t1, nodes 1233 to 1235 have got a configuration Ct2, which was up-to-date at a point of time t2, and node 1236 has got a configuration Ct1, which was up-to-date at a point of time t1.

Configuration Ct0 includes nodes 1231 and 1233 to 1236, configuration Ct1 includes nodes 1231 to 1236, and the actual, i.e., most up-to-date, configuration Ct2 includes nodes 1231 to 1235.

At time t4 all of nodes 1231-1236 are down. At a point of time t5 the cluster gets started with all accessible nodes 1231-1234 having the correct configuration, as depicted in FIG. 12c, t6. At time t6 nodes 1231-1234 are up while nodes 1235 and 1236 are down.

FIG. 12d describes what events can lead to different cluster definitions on different nodes. Four nodes 1241 to 1244 are connected via a network 1245. At time to a cluster consisting of the nodes 1241 to 1244 is defined. The according cluster definition Ct0 is stored on nodes 1241 to 1244. The nodes 1241 to 1243 are up, the node 1244 is down. A network failure separates node 1244 from the remaining nodes of the cluster. At time t1 the node 1241 is stopped. At time t2 the node 1241 is successfully removed form the cluster. This leads to the following situation at time t3: Nodes 1242 and 1243 are up while nodes 1241 and 1244 are down. Node 1241 does not have a cluster definition. Nodes 1242, 1243 have a new cluster definition Ct2 consisting of nodes 1242 to 1244. Node 1244 still has cluster definition Ct0. At time t4 the whole cluster is stopped. At time t5 the network is repaired then at time t6 all nodes are down and node 1241 has no definition, nodes 1242, 1243 have definition Ct2 and node 1244 hat definition Ct0.

After t6 the following subclusters can be started provided the nodes are connected: {1242, 1243} or {1242, 1244} or {1243, 1244} or {1242, 1243, 1244}. All started nodes will use the configuration Ct2. 1241 will never be started.

FIG. 12e extends the example from FIG. 12d. At time t7 network error separating 1241 and 1242 from 1243 and 1244 occurs.

At time t8 the cluster is started. This results in the situation depicted for time t9: 1243 and 1244 are up. Both 1243 and 1244 have the definition Ct2. 1241 and 1242 are down. 1242 has definition Ct2. 1241 has no definition.

With reference to FIGS. 13a-c, there are depicted block diagrams illustrating an example of an operational quorum for a 2-node cluster with a critical resource. The two-node cluster 1300 consists of two nodes 1301 and 1302 connected by a network 1305. Nodes 1301 and 1302 have access to a tiebreaker 1307 (“!”) and to a critical resource CR.

FIG. 13a shows the initial situation where both nodes 1301 and 1302 are down and the network between these nodes is broken.

FIG. 13b shows the situation after starting the cluster: 1301 is online (in a tie situation), it has the tiebreaker reserved and can access CR. Hence the subcluster consisting of 1301 only has the operational quorum state in_quorum. Node 1302 is down.

FIG. 13c shows the situation after starting node 1302 provided 1302 has a cluster definition: 1302 is online but has failed to reserve the tiebreaker. Node 1302 cannot access CR. The subcluster consisting of node 1302 only has the operational quorum state quorum_pending or no_quorum.

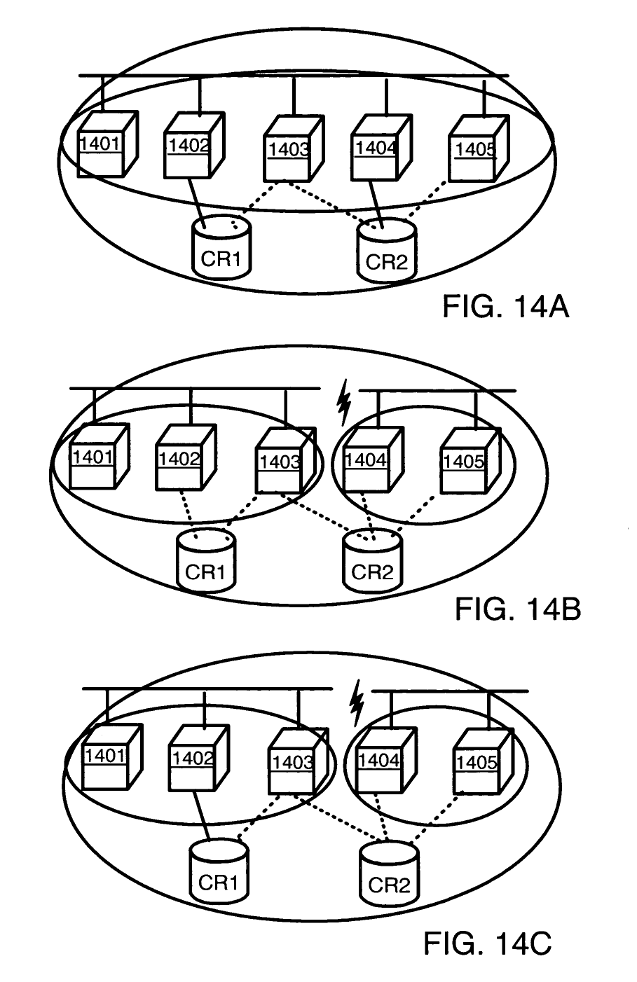

With reference to FIG. 14 a-c, there is depicted a block diagram illustrating an example of an operational quorum for a 5-node cluster with a critical resource. The nodes 1401 to 1405 are connected by a network. Nodes 1401 to 1405 form a configured cluster. Nodes 1402 and 1403 have potential access to a critical resource CR1. Nodes 1403 to 1405 have potential access to another critical resource CR2.

FIG. 14a shows the initial situation where the nodes 1401 to 1405 are up and form an active subcluster with operational quorum state in_quorum. Node 1402 accesses CR1 (solid line), and 1404 accesses CR2 (solid line).

FIG. 14b shows the situation after a network failure that separates nodes 1401 to 1403 from 1404 to 1405. Now nodes 1401 to 1403 form one active subcluster, and nodes 1404 and 1405 form another active subcluster, and the operational quorum states of both active subclusters need to be recomputed.

FIG. 14c shows the result of the determination of the Operational Quorum. The active subcluster consisting of nodes 1401 to 1403 has the state in_quorum. Node 1402 continues to access CR1. The subcluster consisting of node 1404 and 1405 has no_quorum. Before the split 1404 had CR2 online therefore 1404 is stopped. Node 1405 may continue to run because it has no critical resources online.

After this situation node 1403 may access CR2 (e.g. to take over the duties of node 1404), while node 1405 may not access CR2.

The present invention can be realized in hardware, software, or a combination of hardware and software. Any kind of computer system—or other apparatus adapted for carrying out the methods described herein—is suited. A typical combination of hardware and software could be a general-purpose computer system with a computer program that, when being loaded and executed, controls the computer system such that it carries out the methods described herein. The present invention can also be embedded in a computer program product, which comprises all the features enabling the implementation of the methods described herein, and which—when loaded in a computer system—is able to carry out these methods.

Computer program means or computer program in the present context mean any expression, in any language, code or notation, of a set of instructions intended to cause a system having an information processing capability to perform a particular function either directly or after either or both of the following a) conversion to another language, code or notation; b) reproduction in a different material form.

What is claimed is:

1. A method for initializing a cluster having a plurality of nodes, comprising the steps of:
selecting a plurality of nodes to form a cluster configuration;
storing selection information in a cluster configuration file having a current timestamp, said cluster configuration file being locally available on each of said nodes;
determining whether a majority of the nodes are able to access said cluster configuration file;
if so, then generating a message indicating that cluster set-up was successful; and
if not, then attempting to undo the cluster configuration and generating a message indicating that the cluster configuration may be inconsistent.

2. The method of claim 1, wherein the step of storing selection information in a cluster configuration file comprises the step of:
sending the cluster configuration file to all of said nodes.

3. The method of claim 1, wherein the step of storing selection information in a cluster configuration file comprises the step of:
storing the cluster configuration file on a distributed file system accessible by all of said nodes.

4. A computer cluster having a plurality of nodes operated according to the method of claim 1.

5. A computer system adapted to perform the method of claim 1.

6. A computer program product stored on a computer usable medium, comprising computer readable program means for causing a computer to perform the method of claim 1.

7. A method for starting a node in a computer cluster having a plurality of nodes, comprising the steps of:
searching for an up-to-date cluster configuration file defining a cluster;
if an up-to-date cluster configuration file is found, then determining whether or not the node to be started is a member of the cluster defined in the cluster configuration file;
if so, starting the node as a node of the cluster defined in the cluster configuration file; and
if no up-to-date cluster configuration file is found or if the node to be started is not a member of a cluster defined in an up-to-date cluster configuration file, then generating an error message.

8. The method of claim 7, wherein the step of searching for an up-to-date cluster configuration file comprises the steps of:
initially using a locally accessible cluster configuration file as a working configuration file; and
performing an iterative procedure comprising the steps of:
contacting all nodes listed in the working configuration file and asking for their local cluster configuration files;
if a cluster configuration file received from a contacted node is a more recent version than the working configuration file, then making the more recent version the working configuration file and repeating the procedure; and
if no cluster configuration file received from a contacted node is a more recent version than the working configuration file, making the working configuration file the up-to-date cluster configuration file and stopping the procedure.

9. The method of claim 8, further comprising the steps of:
determining how many of the contacted nodes have a cluster configuration file;
if at least half of the nodes listed in the working configuration file have a cluster configuration file, then making the working configuration file the up-to-date cluster configuration file;
otherwise, making no configuration file the up-to-date cluster configuration file.

10. A computer cluster having a plurality of nodes operated according to the method of claim 7.

11. A computer system adapted to perform the method of claim 7.

12. A computer program product stored on a computer usable medium, comprising computer readable program means for causing a computer to perform the method of claim 7.

13. A method for performing a requested operation of adding a set of j nodes to an active subcluster of a configured cluster, where N is the size of the configured cluster and k is the size of the active subcluster, the method comprising the steps of:
determining whether or not 2k<N or 2k<N+j; and
if so, generating an error message indicating that the requested operation would cause inconsistent cluster configuration.

14. The method of claim 13, further comprising the step of:
checking connectivity to the nodes to be added.

15. The method of claim 14, further comprising the step of:
if one or more nodes cannot be reached, adjusting the set of nodes to be added according to the result of the checking step.

16. The method of claim 13, further comprising the step of:
after determining that the nodes can safely be added to the cluster, propagating a new cluster configuration containing the nodes to be added to all nodes in the active subcluster.

17. The method of claim 16, further comprising the steps of:
copying the new cluster configuration to offline nodes, including the nodes that were added.

18. The method of claim 17, further comprising the step of:
returning a list of successfully added nodes.

19. A computer cluster having a plurality of nodes operated according to the method of claim 13.

20. A computer system adapted to perform the method of claim 13.

21. A computer program product stored on a computer usable medium, comprising computer readable program means for causing a computer to perform the method of claim 13.

22. A method for removing a set of j nodes from a cluster configuration, where N is the size of a configured cluster and k is the size of an active subcluster, the method comprising the steps of:
determining whether 2k<N; and
if so, generating an error message indicating that removing the set of nodes would cause inconsistent cluster configuration.

23. The method of claim 22, wherein an administrator is allowed to explicitly ignore a potential error message and continue.

24. The method of claim 22, further comprising the steps of:
checking connectivity to the nodes to be removed; and
if one or more nodes cannot be reached, adjusting the set of nodes to be removed according to the result of the checking step.

25. The method of claim 22, further comprising the step of:
after determining that the requested nodes can safely be removed from the cluster, removing from the configuration all nodes to be removed.

26. The method of claim 25, further comprising the step of:
if the step of removing nodes from the configuration is not successful and 2k=N, then generating an error message indicating that the requested operation would cause inconsistent cluster configuration.

27. The method of claim 26, wherein an administrator is allowed to explicitly ignore a potential error message and continue.

28. The method of claim 25, further comprising the step of:
propagating a new cluster configuration omitting the nodes to be removed to all nodes in the active subcluster if the nodes to be removed could be removed from the configuration.

29. The method of claim 28, further comprising the step of:
copying the new cluster configuration to offline nodes.

30. The method of claim 29, further comprising the step of:
returning a list of successfully removed nodes.

31. A computer cluster having a plurality of nodes operated according to the method of claim 22.

32. A computer system adapted to perform the method of claim 22.

33. A computer program product stored on a computer usable medium, comprising computer readable program means for causing a computer to perform the method of claim 22.

34. A method for performing a requested operation of introducing an update to a cluster configuration, where N is the size of a configured cluster and k is the size of an active subcluster, the method comprising the steps of:
determining whether 2k<N; and
if yes, generating an error message indicating that the requested operation would cause inconsistent cluster configuration.

35. The method of claim 34, further comprising the step of:
propagating a new cluster configuration containing the update to all nodes in the active subcluster if the requested update can safely be introduced.

36. The method of claim 35, further comprising the step of:
copying the new cluster configuration to offline nodes.

37. The method of claim 36, further comprising the step of:
returning a list of nodes on which the requested update to the cluster configuration has been successfully applied.

38. A computer cluster having a plurality of nodes operated according to the method of claim 34.

39. A computer system adapted to perform the method of claim 34.

40. A computer program product stored on a computer usable medium, comprising computer readable program means for causing a computer to perform the method of claim 34.

41. A method for operating a cluster having a plurality of nodes and a tiebreaker, where N is the size of a configured cluster and k is the size of an active subcluster, by determining a state associated with each node, the method comprising the steps of:
retrieving values for N and k; and
if 2k<N, determining whether or not the node has the tiebreaker reserved and, if so:
releasing the tiebreaker;
setting the state to “no quorum”; and
triggering a resource protection method if the node has critical resources online.

42. The method of claim 41, further comprising the step of:
if 2k=N, setting the state to “quorum pending” and requesting a reservation of the tiebreaker.

43. The method of claim 42, further comprising the step of:
changing the state to “in quorum” if the requested reservation was successful.

44. The method of claim 42, further comprising the step of:
changing the state to “no quorum” if the requested reservation was not successful, and
triggering a resource protection method if the node has critical resources online.

45. The method of claim 41 further comprising the step of:
if 2k>N, determining whether the node has the tiebreaker reserved and, if so:
releasing the tiebreaker and
setting the state to “in quorum”.

46. A computer cluster having a plurality of nodes operated according to the method of claim 41.

47. A computer system adapted to perform a method according to claim 41.

48. A computer program product stored on a computer usable medium, comprising computer readable program means for causing a computer to perform a method according to claim 41.

49. A method for determining a malfunction in the operation of a node of a computer cluster, the node having a dead man switch (DMS) and at least a first and a second infrastructure level, the method comprising the steps of:
having said first infrastructure level periodically update the DMS so that the first infrastructure level can be monitored;
having said first infrastructure level monitor said second infrastructure level; and
discontinuing updating of the DMS if said first infrastructure level detects a malfunction while monitoring said second infrastructure level.

50. The method of claim 49, wherein the detecting of malfunction in the second infrastructure level comprises the steps of:
sending a notification message from said first infrastructure level to said second infrastructure level;
waiting for the said second infrastructure level to invoke a function on said first infrastructure level; and
declaring a malfunction on the second infrastructure level if said first infrastructure level fails to receive a function invocation from said first infrastructure level.

51. The method of claim 49, wherein said node additionally includes a third infrastructure level, said method further comprising the steps of:
having said second infrastructure level monitor said third infrastructure level; and
notifying said first infrastructure level if said second infrastructure level detects a malfunction while monitoring said third infrastructure level.

52. The method of claim 49, further comprising the steps of:
performing the method only on nodes where a critical resource is online, and
disabling the method on nodes where no critical resources are online.

53. A computer cluster having a plurality of nodes operated according to the method of claim 49.

54. A computer system adapted to perform a method according to claim 49.

55. A computer program product stored on a computer usable medium, comprising computer readable program means for causing a computer to perform a method according to claim 49.
